(19) United States
(12) Patent Application Publication
(10) Pub. No.: US 2017/0238374 A1
(43) Pub. Date: Aug. 17, 2017

(54) Hand Held Induction Heater and Transformer Therefor

(71) Applicant: David R. Pacholok, Sleepy Hollow, IL (US)

(72) Inventor: David R. Pacholok, Sleepy Hollow, IL (US)

(21) Appl. No.: 15/044,754

(22) Filed: Feb. 16, 2016

(51) Int. Cl. H05B 6/04; H01F 27/28; H01F 27/24

(52) U.S. Cl. CPC H05B 6/04; H01F 27/24; H01F 27/2823

(57) ABSTRACT

The handheld, self contained, air cooled induction heater includes an input connector for engaging an A.C. power source, a rectifier to convert A.C. to D.C., an inverter which converts the D.C. to A.C. operating at substantially higher frequency than the A.C. power line frequency, a high frequency step-down transformer having magnetic cores, wherein at least a primary winding is split into two substantially equal parts, each part being wound around one of two legs of the transformer magnetic core, and a secondary winding being connected to heat dissipating terminals capable of functional engagement to at least one work coil.

Further according to the invention there is provided a transformer for the induction heater having a primary and secondary wound around both legs magnetic core so that leakage inductance is reduced and power output increased compared to the primary and secondary windings of the same number of turns all wound on one leg of the same shaped magnetic core.

### FIELD OF THE INVENTION

This invention relates to air cooled, self contained, handheld induction heaters used to heat rusted nuts and bolts for removal thereof such as for repair of machinery, automobiles, trucks, rails, chemical plants, petrochemical, etc. Such handheld induction heaters are totally self-contained; that is, they are air cooled and include a high frequency inverter. One end of the tool has a power connecter for connection to utility power, i.e. 120 or 240 VAC, and the other end has attachment terminals for a variety of work coils. This variety of work coils allows efficient heating of different sized nuts, bolts and the like needed in industrial, automotive or other equipment disassembly and/or repair. Other uses for such handheld induction heating equipment include expanding bearing races or housings for bearing removal/replacement, and even annealing metals such as brass shells in firearms ammunition reloading procedures.

### PRIOR ART

Historically, such hand held induction heaters have been limited to a power of about 1000 watts. The reason for this is the limited volume and physical constraints in a handheld tool. A generally cylindrical shape for such tools is preferred allowing ergonomic compatibility with the human hand. As such, the gripping section of the tool is limited to no more than a 3″ diameter, and preferably less. Length is limited for operator ease of use, as are balance and weight. These physical constraints result in the power limitation of about 1000 watts for all handheld, self contained induction heaters on the market. It would be very desirable to increase this power limitation so that small nuts and bolts and the like can be heated more quickly, and larger nuts and bolts, etc. can be heated sufficiently for expansion and thus easy removal.

### SUMMARY OF THE INVENTION

According to the invention there is provided a handheld, self contained, air cooled induction heater including an input connector for engaging a source of A.C. power, a rectifier to convert A.C. to D.C., an inverter which converts the D.C. to A.C. operating at substantially higher frequency than the A.C. power line frequency, a high frequency step-down transformer having magnetic cores shaped generally as the letters “U” or “C”, wherein at least a primary winding is split into two substantially equal parts, each part being wound around one of two legs of the transformer magnetic core, and wherein a secondary winding is split into two substantially equal parts, each part being wound around one of two legs of the transformer magnetic core and being connected to heat dissipating terminals capable of functional engagement to at least one work coil.

Further according to the invention there is provided a transformer for a handheld, self contained, air cooled induction heater having a split primary and split secondary, one part of each being wound around one of the two legs of a “C” or “U” shaped magnetic core so that leakage inductance is reduced and power output increased compared to primary and secondary windings of the same number of turns all wound on one leg of an identical “U” or “C” shaped magnetic core.

### BRIEF DESCRIPTION OF THE DRAWINGS

FIG. 1 presents a sectional view through the air gap of a prior art transformer with a primary winding and a secondary winding over the primary.

FIG. 2 presents a top plan view of the prior art transformer of FIG. 1.

FIG. 3 presents a schematic view of a prior art induction heater comprising, from left to right, a power input connector, a rectifier, an inverter or power supply circuit with momentary switch control, a transformer as in FIGS. 1 and 2, and heat dissipating terminal connections for a work coil.

FIG. 4 provides a sectional view through the air gap of the transformer of the present invention with one half of the primary windings on each leg of the core and one half of the secondary windings over each primary section.

FIG. 5 provides a top plan view of transformer in FIG. 4.

FIG. 6 provides a schematic view of an induction heater system as in FIG. 3 with the improved transformer of the present invention as in FIGS. 4 and 5, with primary windings wired in series and secondary windings wired in series.

FIG. 7 is similar to FIG. 6 with the improved transformer as in FIGS. 4 and 5, with the primary windings wired in parallel and secondary windings wired in series.

FIG. 8 is similar to FIG. 6 with the improved transformer as in FIGS. 4 and 5, with the primary windings wired in parallel and the secondary windings wired in parallel.

### DESCRIPTION OF THE PREFERRED EMBODIMENTS

As will become clearer after a thorough perusal of this application, three main principles of electronics are applicable to the invention as listed below.

### Resistance of Each Winding

Rp or Rs=MLT*Rcu*N where:
Rp=Primary Winding Resistance
Rs=Secondary Winding Resistance
Rcu=Copper Resistance (μΩ/cm)
N=Turn Count

### Temperature Rise Estimate

ΔT=(PΣ/At)^{0.833} where:
ΔT=Temperature Rise in ° C.
PΣ=Total Transformer Losses in mW/cc
(Power dissipated in the form of heat)
At=Surface Area of Transformer in cm²

### Creation of the Exponent in the Temperature Rise Formula

x=ln(PΣ@1^{st} ΔT/P Σ@2^{nd} ΔT/2^{nd} ΔT)

As an introduction, bearing in mind the above equations, it will be understood by those skilled in the art that winding on both legs of the core reduces the mean length/turn by 10-15%. As a result, the 10-15% R drop produces less heat (I²R). In addition, by winding on both legs the surface area of the transformer available for heat dissipation will increase by approximately 50%. (A_{T})

In tests of two commercial products, called the Miniductor II™ and the Bolt Buster™, it was determined that the power limiting factor is temperature rise of the high frequency transformer within all such handheld, self contained induction heating devices or heaters. The need for this transformer is two-fold. First, the high frequency inverter within these devices operates at power line voltages, typically 100-240 volts, necessitated by their direct connection to standard power line voltage supplies. The work coils in contrast, operate at several 10's of volts and high current to allow for a small, practical number of work coil turns, typically 1 to 5 turns, of heavy gauge wire. The transformer “matches” the high voltage, low I inverter to the low voltage, high current work coil. Second, the high frequency transformer galvanically isolates the dangerous high voltage from the power line-connected inverter from the user-accessible work coil.

Due to the dimensional constraints of the handheld, self contained induction heater, especially the maximum diameter comfortable for the human hand, the transformer design choices are limited. E-core geometries are too bulky. Toroidal cores are attractive due to high wattage/volume capability, but are expensive to wind and difficult to gap to control inductance for efficient resonant inverter operation. In addition, the wound diameter of a torrid must be less than 3″ minus the case thickness x2 in order to physically fit into a practical, ergonomic case. This limits the available core area and power throughput. Heretofore, the chosen transformer design is one using two long legged “U” or “C” cores of 2-4 cm² cross sectional ferrite area to support the needed magnetic flux. Such cores are typically used in television and monitor applications as the “flyback” transformer and typically have one round and one rectangular leg. A set of 2 cores is needed to complete a transformer. It is basically gapped by insertion of the desired thickness of discs of non-conductive, non-magnetic material into the gap such as hard paper or plastic. Such a core set is designed to be wound only on the round legs, with the rectangular legs having no windings around them. Their purpose is only to complete the magnetic flux path generated by the wound, round legs of the transformer core.

It has been experimentally found that winding half of the primary and secondary turns on the rectangular leg and half on the round leg leads to dramatic reductions in peak winding temperature, for a given power transferred, and thus much higher power output capability at greater duty cycle.

For example, the temperature rise of the conventional transformer was compared to the new transformer. The same work coil consisting of two turns of #8 AWG wire, loaded by a 1.5″ diameter mild steel pipe was used to test temperature rise of both transformers. The A.C. input voltage was 120.0 VAC in both cases. Starting temperature was 30° C. in all cases. Temperature was measured by type K thermocouples and yielded results as shown in the following table.

| | Conventional Transformer | | New Transformer | |
|---|---|---|---|---|
| | T, ° C. | Power Watts | T, ° C. | Power |
| 1 minute | 39 | 938 | 45 | 1242 |
| 2 minutes | 88 | 942 | 58 | 1250 |
| 3 minutes | 113 | 957 | 75 | 1258 |
| 4 minutes | 137 | 969 | 92 | 1263 |
| 5 minutes | 156* | 981 | 113 | 1268 |
| 10 minutes | | | 149 | 1282 |

*Exceeds 150° C. temperature rating of insulation

It was discovered that the temperature rise for the transformer of the present invention was considerably lower, as expected. An unexpected result was the 250-300 watt increase in measured power. The number of turns on the prior art and present transformers was the same, 30 turns primary and 4 turns secondary. It was determined that the reason for the increased power was due to the vastly reduced primary to secondary leakage inductance in the instant transformer. Leakage inductance may be approximately measured by shorting the secondary and measuring the primary inductance. A perfect transformer, having zero leakage, would measure zero micro-Henries with its secondary shorted. Real transformers have finite leakage inductance. Leakage inductance acts as a series impedance with the load, reducing current, voltage and therefore power to the load. The prior art transformer showed 13.2 μH leakage inductance, while the instant transformer only 5.3 μH, explaining the increased power.

The lower leakage inductance and lower temperature rise are very desirable results. The new transformer delivers ⅓more power for twice the time before overheat. The improved induction heater using the disclosed transformer is therefore capable of heating larger nuts, bolts and metallic obj ects to a given temperature in shorter time, or heating large objects to a higher temperature before transformer thermal limitations are reached.

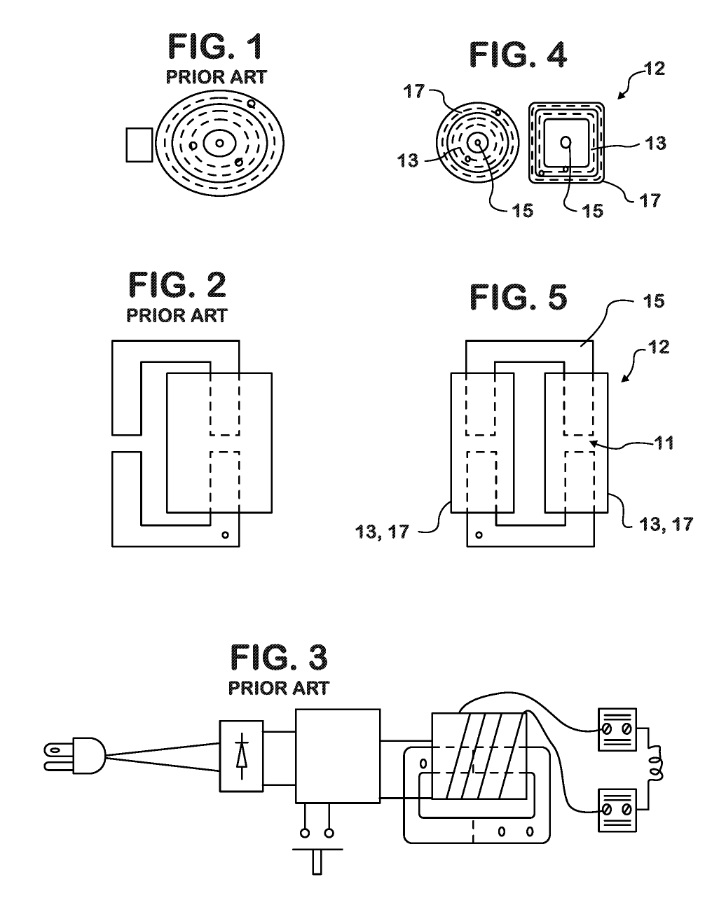

Turning now to the Figures, it will be understood that FIGS. 1-3 provide various views of a common prior art embodiment which would be well known to those skilled in the art and not requiring any definition thereof.

Beginning with FIG. 4 a cross sectional view through an air gap 11 of the transformer 12 of the present invention is illustrated with one half of a primary winding 13 on each leg of the core 15, and one half of the secondary winding 17 being wound over each half of the primary winding.

FIG. 5 presents a top plan view of the transformer 12 of the present invention, showing primary and secondary windings wound thereover with the primary winding 13 being positioned beneath the secondary winding 17 in all embodiments.

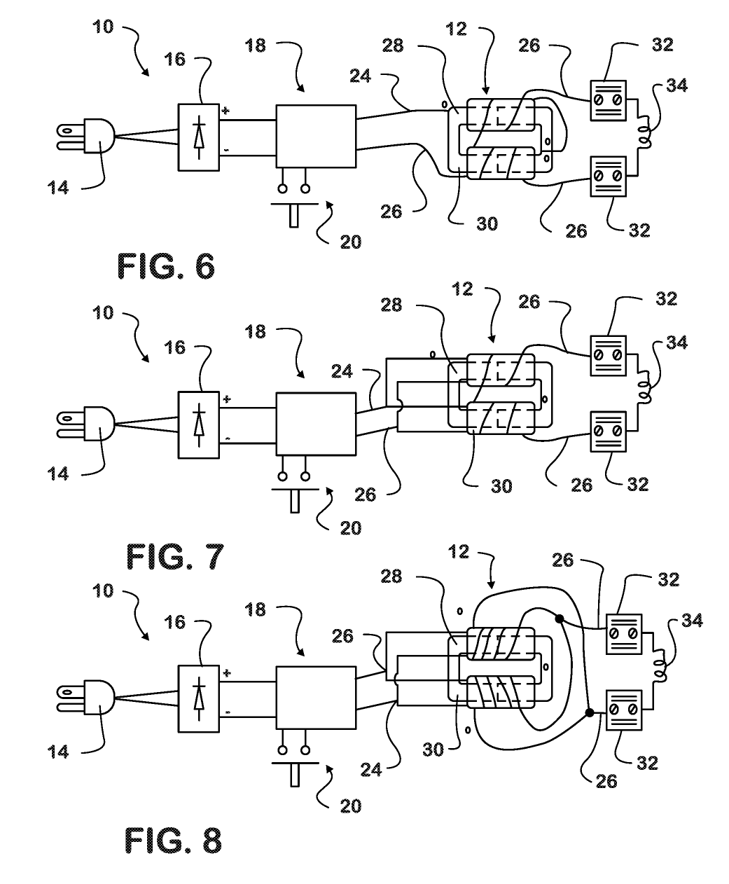

As illustrated in FIG. 6, the newly devised transformer 12 of the present invention is shown incorporated into a handheld induction unit 10. As illustrated, going from left to right, a power input connector 14 connects to an alternating current power source (not shown). Rectifier 16 converts the alternating line current from power source input connector 14 into a high voltage direct current which energizes the power supply circuit 18. The power supply circuit 18 comprising inverter 18 converts the rectified direct current into high frequency, high voltage alternating current when the momentary switch control 20 is closed.

Next is introduced the transformer 12 of the present invention wherein winding half of the turns of the primary and secondary winding 24 and 26, respectively, on the rectangular leg 28 and half on the round leg 30 leads to dramatic reductions in peak winding temperature, for a given power transferred, and thus much higher power output capability at greater duty cycle. In this embodiment, which will be understood to those skilled in the art, the primary and secondary windings are connected in series. Next the secondary windings 26 are each connected to corresponding heat dissipating terminals 32 which are also capable of functional engagement to a work coil 34 which allow various work coils 34 to be installed, depending on the application of the device. Finally the work coil 34 converts high frequency high current alternating current into a high frequency alternating magnetic field which heats a metallic or conductive object (not shown) which is placed within the magnetic flux lines emanating from the work coil 34. Here it will be understood by those skilled in the art how the above equations were applied to create the transformer 12 of the present invention.

FIG. 7 presents an induction heater 10 as in FIG. 6 with the transformer 12 of FIGS. 4 and 5, wherein the primary windings are wired in parallel and the secondary windings are wired in series.

FIG. 8 presents an induction heater 10 as in FIG. 6 with the transformer 12 of FIGS. 4 and 5, wherein the primary windings are wired in parallel and the secondary windings are wired in parallel.

FIGS. 6 through 8 are presented to show the versatility of the transformer 12.

As described above, the induction heater 10 of the present invention provides a number of advantages, some of which have been described above and others of which are inherent in the invention. Further, modifications may be proposed without departing from the teachings herein. Accordingly the scope of the invention should only be limited as necessitated by the accompanying claims.

1. A handheld, self contained, air cooled induction heater including an input connector for engaging a source of A.C. power, a rectifier to convert A.C. to D.C., an inverter which converts the D.C. to A.C. operating at substantially higher frequency than the A.C. power line frequency, a high frequency step-down transformer having magnetic cores shaped generally as the letters “U” or “C”, wherein at least a primary winding of the high frequency step down transformer is split into two substantially equal parts, each part being wound around only one of two legs of the transformer magnetic core, and a secondary winding is connected to heat dissipating terminals capable of functional engagement to at least one work coil.

2. The induction heater of claim 1, wherein the secondary winding of the high frequency step down transformer is split into two substantially equal parts, each part being wound around one of the two legs of the transformer magnetic core.

3. The induction heater of claim 2 wherein the secondary winding parts are connected in series.

4. The induction heater of claim 2 wherein the secondary winding parts are connected in parallel.

5. The induction heater of claim 1 wherein the two parts of the primary windings are connected in series.

6. The induction heater of claim 1 wherein the two parts of the primary windings are connected in parallel.

7. A transformer for a handheld, self contained, air cooled induction heater having a primary winding and a secondary winding, each winding being split into two parts and having one part thereof wound around each of two legs of a “C” or “U” shaped magnetic core so that leakage inductance is reduced and power output increased compared to the primary windings and secondary windings of the same number of turns all wound around only one leg of the same “U” or “C” shaped magnetic core.

8. In a handheld, self contained, air cooled induction heater, the improvement comprising a step down transformer having primary and secondary windings each split into two parts, with each part of each winding being wound around only one of two legs of a “C” or “U” shaped magnetic core so that leakage inductance is reduced and power output increased compared to the primary and secondary windings of the same number of turns all wound on one leg of an identical “U” or “C” shaped magnetic core, where the decrease in temperature rise in the high frequency transformer is calculated through use of equations:
Resistance of Each Winding
Rp or Rs=MLT*Rcu*N where:
Rp=Primary Winding Resistance
Rs=Secondary Winding Resistance
Rcu=Copper Resistance (μΩ/cm)
N=Turn Count;
Temperature Rise Estimate
ΔT=(P Σ/At)^{0.833} where:
ΔT=Temperature Rise in ° C.
PΣ=Total Transformer Losses in mW/cc
(Power dissipated in the form of heat)
At=Surface Area of Transformer in cm²; and
Creation of the Exponent in the Temperature Rise Formula
x=ln(PΣ@1^{st} ΔT/P Σ@2^{nd} ΔT/2^{nd} ΔT)
